(19) United States
(12) Patent Application Publication
(10) Pub. No.: US 2025/0297459 A1
(43) Pub. Date: Sep. 25, 2025

(54) MOVABLE ARM DAMPING SYSTEM FOR LOADING MACHINE AND LOADING MACHINE

(71) Applicant: Shanghai Sany Heavy Machinery Co., Ltd., Shanghai (CN)

(72) Inventors: Lichun MA, Shanghai (CN); Zida LIU, Shanghai (CN); Weian JIANG, Shanghai (CN)

(73) Assignee: Shanghai Sany Heavy Machinery Co., Ltd., Shanghai (CN)

(21) Appl. No.: 19/229,129

(22) Filed: Jun. 5, 2025

Related U.S. Application Data
(63) Continuation of application No. 18/192,995, filed on Mar. 30, 2023.
Application No. 18/192,995 is a continuation of application No. PCT/CN2021/141660, filed on Dec. 27, 2021.

(30) Foreign Application Priority Data
Jan. 29, 2021 (CN) 202110129408.9

(51) Int. Cl. E02F 9/22; F15B 1/04; F15B 21/00

(52) U.S. Cl. CPC E02F 9/2207; E02F 9/2217; E02F 9/2267; E02F 9/2271; F15B 1/04; F15B 21/008; E02F 9/2285

(57) ABSTRACT

Disclosed are a movable arm damping system for a loading machine and an operation machinery. The movable arm damping system for the loading machine includes a multi-way valve assembly, a movable arm oil cylinder, a movable arm damping valve assembly, and a damping lock valve. The multi-way valve assembly includes a movable arm valve core and a bucket valve core. A first movable arm oil port of the movable arm valve core communicates with a rod cavity of the movable arm oil cylinder, and a second movable arm oil port of the movable arm valve core communicates with a rodless cavity of the movable arm oil cylinder. A switching oil port of the damping lock valve communicates with a switching oil port of the bucket valve core.

### CROSS-REFERENCE TO RELATED APPLICATIONS

The present application is a continuation of U.S. patent application Ser. No. 18/192,995, filed on Mar. 30, 2023, which is a continuation of International Application No. PCT/CN2021/141660, filed on Dec. 27, 2021. The International Application No. PCT/CN2021/141660 claims priority to Chinese Patent Application No. 202110129408.9, filed on Jan. 29, 2021. All of the afore-mentioned patent applications are hereby incorporated by reference in their entireties.

### TECHNICAL FIELD

The present application relates to the technical field of operation machinery, and specifically to a movable arm damping system for a loading machine and a loading machine.

### BACKGROUND

A loading machine has a rigid connection between a wheel edge support and a vehicle frame. When the loading machine is running on an uneven road, the whole vehicle will sway with the front axle as the center which sometimes may cause the rear axle to leave the ground. In this case, the driver's body will sway with the whole vehicle, resulting in poor driving comfort. As operation devices, heavy matters and other parts of the machine will response to the ground or obstacles, strong vibration and impact occur, causing materials in the bucket to fall out and affecting the operation efficiency. In order to reduce vibration during running and improve driving comfort and operation efficiency, more and more loading machines are provided with movable arm damping function.

During operation of bucket loading of the loading machine, it is required that the movable arm damping function is in the disabled state. When the loading machine is transferred for a long distance, the movable arm damping function is enabled to reduce bumping of the whole machine and increase running speed. The movable arm damping function is such that the pressure pulse and flow fluctuation of the large cavity of the movable arm oil cylinder are absorbed by the energy accumulator, adjusting the stroke of the piston rod, reducing the amplitude of vertical fluctuation of the gravity center of the bucket, and thus eliminating bumping of the whole machine. Therefore, the damping effect of the whole machine is determined by the internal oil liquid pressure and volume of the energy accumulator.

### SUMMARY

In the present application, a movable arm damping system for a loading machine is provided, to solve the problem of significant decrease in bucket level/height due to bucket unloading and pressing downward on the movable arm mechanism.

In the present application, a movable arm damping system for a loading machine is provided, including: a multi-way valve assembly, a movable arm oil cylinder, a movable arm damping valve assembly, and a damping lock valve. The multi-way valve assembly includes a movable arm valve core and a bucket valve core. A first movable arm oil port of the movable arm valve core is configured to communicate with a rod cavity of the movable arm oil cylinder, a second movable arm oil port of the movable arm valve core is configured to communicate with a rodless cavity of the movable arm oil cylinder, the rod cavity of the movable arm oil cylinder is configured to communicate with the movable arm damping valve assembly, and the rodless cavity of the movable arm oil cylinder is configured to communicate, via the damping lock valve, with the movable arm damping valve assembly. The damping lock valve is provided with a damping connection position and a damping disconnection position, and a switching oil port of the damping lock valve is configured to communicate with a switching oil port of the bucket valve core such that when a pressure at the switching oil port of the damping lock valve reaches a preset pressure during a bucket unloading process, the damping lock valve switches from the damping connection position to the damping disconnection position.

According to the movable arm damping system for the loading machine, the movable arm damping system for the loading machine further includes an energy accumulator and an oil tank pipeline. The energy accumulator is configured to communicate, via the movable arm damping valve assembly, with the rodless cavity of the movable arm oil cylinder for maintaining a constant supplying oil pressure. The oil tank pipeline is configured to communicate with the movable arm damping valve assembly, the movable arm valve core and the bucket valve core for supplying oil.

According to the movable arm damping system for the loading machine, the movable arm damping valve assembly includes a damping valve core. The damping valve core is provided with a first damping oil port and a second damping oil port. The first damping oil port is configured to communicate the rod cavity of the movable arm oil cylinder with the oil tank pipeline, and the second damping oil port is configured to communicate the rodless cavity of the movable arm oil cylinder with the energy accumulator.

According to the movable arm damping system for the loading machine, the damping valve core is provided with a fourth working position for connection of the first damping oil port and connection of the second damping oil port, at the fourth working position, the first damping oil port communicates the rod cavity of the movable arm oil cylinder with the oil tank pipeline, and the second damping oil port communicates the rodless cavity of the movable arm oil cylinder with the energy accumulator; a first working position for connection of the second damping oil port and disconnection of the first damping oil port, at the first working position, the rod cavity of the movable arm oil cylinder disconnects with the oil tank pipeline, and the second damping oil port communicates the rodless cavity of the movable arm oil cylinder with the energy accumulator; and a second working position for disconnection of the first damping oil port and disconnection of the second damping oil port, at the second working position, the rod cavity of the movable arm oil cylinder disconnects with the oil tank pipeline, and the rodless cavity of the movable arm oil cylinder disconnects with the energy accumulator.

According to the movable arm damping system for the loading machine, the damping valve core further has a third working position for connecting the energy accumulator and the oil tank pipeline.

According to the movable arm damping system for the loading machine, the movable arm damping valve assembly further includes a one-way throttle valve group and a solenoid directional valve. A switching oil port of the damping valve core is configured to communicate, via the one-way throttle valve group, with the solenoid directional valve, and the solenoid directional valve has two working positions for connecting or disconnecting the rodless cavity of the movable arm oil cylinder and the energy accumulator.

According to the movable arm damping system for the loading machine, the movable arm damping valve assembly further includes an overflow valve; the first damping oil port is configured to communicate, via the overflow valve, with the energy accumulator, and the overflow valve is used for limiting the pressure of the energy accumulator.

According to the movable arm damping system for the loading machine, the movable arm damping valve assembly further includes a switch valve. The second damping oil port is configured to communicate, via the switch valve, with the first damping oil port, the switch valve has a connection position for communicating the first damping oil port and the second damping oil port, and a disconnection position for disconnecting the first damping oil port and the second damping oil port.

In the present application, a loading machine is further provided. The loading machine includes a movable arm damping system for the loading machine. The movable arm damping system for the loading machine includes: a multi-way valve assembly, a movable arm oil cylinder, a movable arm damping valve assembly and a damping lock valve. The multi-way valve assembly includes a movable arm valve core and a bucket valve core. A first movable arm oil port of the movable arm valve core is configured to communicate with a rod cavity of the movable arm oil cylinder, a second movable arm oil port of the movable arm valve core is configured to communicate with a rodless cavity of the movable arm oil cylinder, the rod cavity of the movable arm oil cylinder is configured to communicate with the movable arm damping valve assembly, and the rodless cavity of the movable arm oil cylinder is configured to communicate, via the damping lock valve, with the movable arm damping valve assembly. The damping lock valve is provided with a damping connection position and a damping disconnection position, and a switching oil port of the damping lock valve is configured to communicate with a switching oil port of the bucket valve core such that when a pressure at the switching oil port of the damping lock valve reaches a preset pressure during a bucket unloading process, the damping lock valve switches from the damping connection position to the damping disconnection position.

In the movable arm damping system for the loading machine and the loading machine as provided in the present application. By adding the damping lock valve having the damping connection position and the damping disconnection position to connect the rodless cavity of the movable arm oil cylinder with the movable arm damping valve assembly and connect the switching oil port of the damping lock valve with the switching oil port of the bucket valve core, the damping lock valve is controlled by a pilot pressure of the unloading position, such that when a pressure at the switching oil port of the damping lock valve reaches a preset pressure, the damping lock valve switches from the damping connection position to the damping disconnection position, and therefore effectively solving the problem of significant decrease in bucket level/height due to bucket unloading and pressing downward on the movable arm mechanism.

### BRIEF DESCRIPTION OF THE DRAWINGS

In order to explain the technical solutions in the present application or prior art more clearly, the figures necessary to be used in the description of the embodiments or prior art will be briefly introduced hereinafter. Obviously, the figures used in the description as below are for some embodiments of the present application, and based on these figures, those skilled in the art can obtain other figures without any inventive work.

FIG. 1 is a structural diagram of an existing movable arm damping system.

FIG. 2A is a structural diagram of a movable arm damping system as provided in the present application.

FIG. 2B is a structural diagram of a movable arm damping system as provided in the present application.

FIG. 3 is a structural diagram of a damping valve core as provided in the present application.

FIG. 4 is a structural diagram of a movable arm damping valve assembly as provided in the present application.

### DETAILED DESCRIPTION OF THE EMBODIMENTS

In order to make the purposes, technical solutions and advantages of the present application clearer, hereinafter, the technical solutions in the present application will be described clearly and completely in combination with the accompanying drawings in the present invention. Obviously, the described embodiments are some embodiments of the present application, rather than all embodiments. Any other embodiments obtained by those skilled in the art, based on the embodiments of the present application and without any inventive work, will fall within the protection scope of the present application.

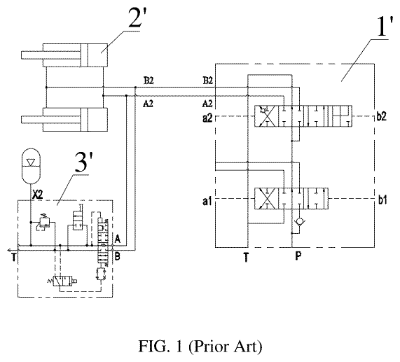

There are two filling manners for the prior energy accumulator: 1) connecting the oil port of the large cavity of the movable arm oil cylinder directly with the oil port of the energy accumulator and filling the energy accumulator by the large cavity of the movable arm oil cylinder (see FIG. 1), where when the oil liquid pressure in the energy accumulator reaches a preset value, the movable arm damping valve assembly 3′ disconnects the connection between the oil port of the large cavity of the movable arm oil cylinder 2′ and the oil port of the energy accumulator; 2) connecting the oil port of the energy accumulator, via a hydraulically or electronically controlled reversing valve, with the oil inlet of the multi-way valve assembly 1′ (i.e. pumping source), where when the pressure of the pumping source is higher than the oil liquid pressure of the energy accumulator, the pumping source performs filling to the energy accumulator.

When the movable arm damping valve assembly 3′ uses a manner of filling the energy accumulator by the large cavity of the movable arm oil cylinder 2′, the bucket unloads material and presses downward on the movable arm mechanism, the movable arm oil cylinder 2′ will significantly retract to cause significant decrease in bucket level/height, resulting in danger for loading.

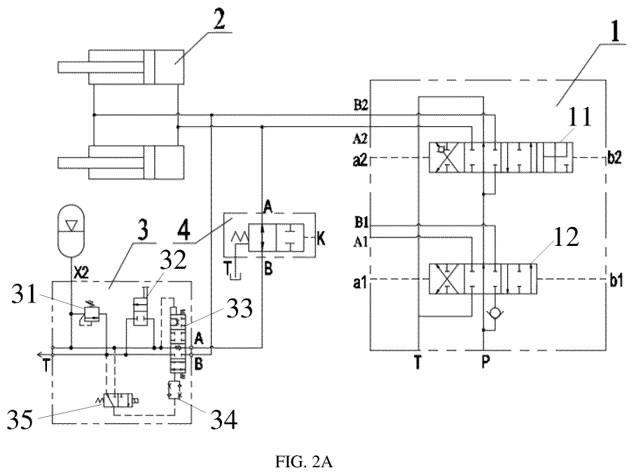

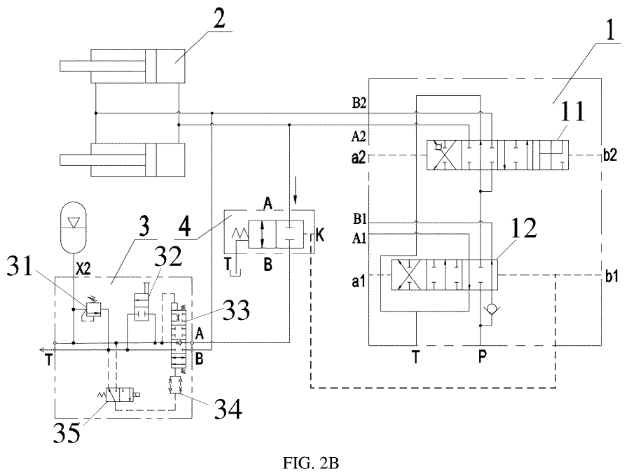

Hereinafter, a movable arm damping system for a loading machine as provided in the present application will be described in combination with FIG. 2A and FIG. 2B. The movable arm damping system for the loading machine includes: a multi-way valve assembly 1, a movable arm oil cylinder 2, a movable arm damping valve assembly 3 and a damping lock valve 4. The multi-way valve assembly 1 includes: a movable arm valve core 11 and a bucket valve core 12. A first movable arm oil port B2 of the movable arm valve core 11 is configured to communicate with a rod cavity of the movable arm oil cylinder 2, a second movable arm oil port A2 of the movable arm valve core 11 is configured to communicate with a rodless cavity of the movable arm oil cylinder 2, the rod cavity of the movable arm oil cylinder 2 is configured to communicate with the movable arm damping valve assembly 3, and the rodless cavity of the movable arm oil cylinder 2 is configured to communicate, via the damping lock valve 4, with the movable arm damping valve assembly 3.

Herein, the damping lock valve 4 has a damping connection position and a damping disconnection position, and a switching oil port K of the damping lock valve 4 is configured to communicate with switching oil port b1 of the bucket valve core 12 such that when a pressure of the switching oil port K of the damping lock valve 4 reaches a preset pressure during a bucket unloading process, the damping lock valve 4 switches from the damping connection position to the damping disconnection position.

In the present embodiment, the movable arm damping system for the loading machine further includes an energy accumulator X2 and an oil tank. The energy accumulator X2 is configured to communicate, via the movable arm damping valve assembly 3, with the movable arm oil cylinder 2 for maintaining a constant oil supply pressure. The oil tank is configured to communicate with the movable arm damping valve assembly 3, the movable arm valve core 11 and the bucket valve core 12. The oil tank is connected with a pipeline T (that is an oil tank pipeline) in FIG. 2A and FIG. 2B and is driven by an oil pump to control oil supply of the whole movable arm damping system for the loading machine.

During operation of the movable arm damping system for the loading machine, after the operator turns off a movable arm damping button, the movable arm damping valve assembly 3 is off. During operation of bucket loading, the pressure in the rod cavity of the movable arm oil cylinder 2 increases and the oil liquid in the movable arm oil cylinder 2 will flow through the movable arm damping valve assembly 3 to the energy accumulator X2, and such process is called energy accumulator X2 filling. When the pressure in the rod cavity of the movable arm oil cylinder 2 is higher than 12.5 MPa, the movable arm damping valve assembly 3 disconnects the oil way connection between the rodless cavity of the movable arm oil cylinder 2 and the energy accumulator X2, and the movable arm damping function is in the disabled state at this time.

After the operator turns on the movable arm damping button, the movable arm damping valve assembly 3 is on. When the bucket does not unload, there is no pressure at the switching oil port K of the damping lock valve 4, the damping lock valve 4 is in the damping connection position, the oil port of the damping lock valve 4 is connected, the rodless cavity of the movable arm oil cylinder 2 communicates with the oil port of the damping lock valve 4, the energy accumulator X2 communicates, via the movable arm damping valve assembly 3, with the oil port of the damping lock valve 4, the rodless cavity of the movable arm oil cylinder 2 communicates, via the movable arm damping valve assembly 3, with the energy accumulator X2, and the movable arm damping function is in the enabled state at this time. When the bucket unloads, there is a control pressure at the switching oil port K of the damping lock valve 4, the damping lock valve 4 is in the damping disconnection position, the oil port of the damping lock valve 4 is disconnected, the oil way between the rodless cavity of the movable arm oil cylinder 2 and the energy accumulator X2 is cut off by the damping lock valve 4, and the rodless cavity of the movable arm oil cylinder 2 communicates only with the second movable arm oil port A2 of the multi-way valve assembly 1. At this time, the movable arm valve core 11 of the multi-way valve assembly 1 is in the closed state, and when the bucket unloads material and presses downward on the movable arm mechanism, the movable arm oil cylinder 2 will not retract.

In the movable arm damping system for the loading machine provided in the present application, by adding the damping lock valve 4 having the damping connection position and the damping disconnection position to connect the rodless cavity of the movable arm oil cylinder 2 with the movable arm damping valve assembly 3 and connect the switching oil port K of the damping lock valve 4 with the switching oil port b1 of the bucket valve core 12, the damping lock valve 4 is controlled by a pilot pressure of the unloading position, such that when a pressure of the switching oil port K of the damping lock valve 4 reaches a preset pressure, the damping lock valve 4 switches from the damping connection position to the damping disconnection position, therefore effectively solving the problem of significant decrease in bucket level/height due to bucket unloading and pressing downward on the movable arm mechanism, and ensuring stable operation of the movable arm damping system for the loading machine.

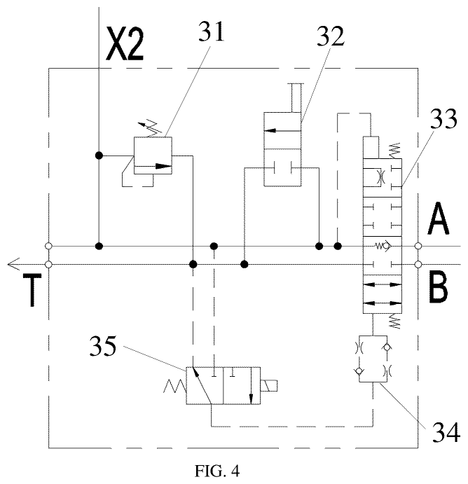

As shown in FIGS. 2-4, the movable arm damping valve assembly 3 includes a damping valve core 33. The damping valve core 33 is provided with a first damping oil port B for connecting the rod cavity of the movable arm oil cylinder 2 with the oil tank 5 and a second damping oil port A for connecting the rodless cavity of the movable arm oil cylinder 2 with the energy accumulator X2.

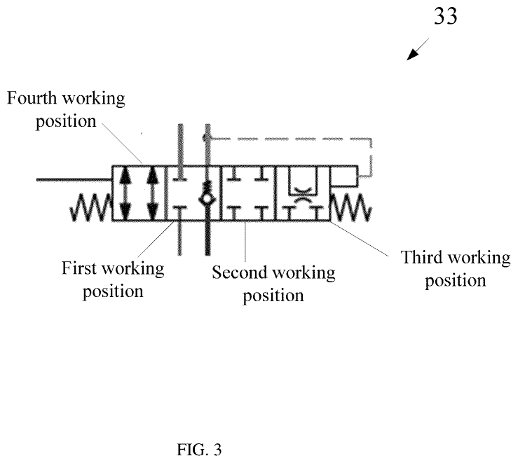

As shown in FIG. 3, the damping valve core 33 has a first working position, a second working position and a fourth working position. The first working position is configured for connection of the second damping oil port A and disconnection of the first damping oil port B, that is, at the first working position, the rod cavity of the movable arm oil cylinder 2 disconnects with the oil tank pipeline (that is pipeline T), and the second damping oil port A communicates the rodless cavity of the movable arm oil cylinder 2 with the energy accumulator X2. The second working position is configured for disconnection of the first damping oil port and disconnection of the second damping oil port, that is, at the second working position, the rod cavity of the movable arm oil cylinder 2 disconnects with the oil tank pipeline, and the rodless cavity of the movable arm oil cylinder 2 disconnects with the energy accumulator X2. The fourth working position is configured for connection of the first damping oil port and connection of the second damping oil port, that is, at the fourth working position, the first damping oil port B communicates the rod cavity of the movable arm oil cylinder 2 with the oil tank pipeline, and the second damping oil port A communicates the rodless cavity of the movable arm oil cylinder 2 with the energy accumulator X2.

In addition, when the pressure of the rodless cavity of the movable arm oil cylinder 2 is further increased, a third working position can be added in the damping valve core 33 for connecting the energy accumulator X2 with the oil tank (through the pipeline T), so that the energy accumulator X2 communicates with the oil tank 5, and thus the oil way pressure can be balanced.

After the operator turns off the movable arm damping button, the movable arm damping valve assembly 3 is off, and the damping valve core 33 is in the first working position at this time. During operation of bucket loading, the pressure in the rod cavity of the movable arm oil cylinder 2 increases and the oil liquid in the movable arm oil cylinder 2 will flow through the movable arm damping valve assembly 3 to the energy accumulator X2, and such process is called energy accumulator X2 filling. When the pressure in the rod cavity of the movable arm oil cylinder 2 is higher than 12.5 MPa, the damping valve core 33 is moved to the second working position, and the movable arm damping valve assembly 3 cuts off the oil way connection between the rodless cavity of the movable arm oil cylinder 2 and the energy accumulator X2, and the movable arm damping function is in the disabled state at this time.

After the operator turns on the movable arm damping button, the movable arm damping valve assembly 3 is on, the damping valve core 33 moves to the fourth working position. When the bucket does not unload, there is no pressure at the switching oil port K of the damping lock valve 4, the damping lock valve 4 is in the damping connection position, the oil port of the damping lock valve 4 is connected, the rodless cavity of the movable arm oil cylinder 2 communicates with the oil port of the damping lock valve 4, the energy accumulator X2 communicates, via the movable arm damping valve assembly 3, with the oil port of the damping lock valve 4, the rodless cavity of the movable arm oil cylinder 2 communicates, via the movable arm damping valve assembly 3, with the energy accumulator X2, and the movable arm damping function is in the enabled state at this time. When the bucket unloads, there is a control pressure at the switching oil port K of the damping lock valve 4, the damping lock valve 4 is in the damping disconnection position, the oil port of the damping lock valve 4 is disconnected, the oil way between the rodless cavity of the movable arm oil cylinder 2 and the energy accumulator X2 is cut off by the damping lock valve 4, and the rodless cavity of the movable arm oil cylinder 2 communicates only with the second movable arm oil port A2 of the multi-way valve assembly 1. At this time, the movable arm valve core 11 of the multi-way valve assembly 1 is in the closed state, and when the bucket unloads material and presses downward on the movable arm mechanism, the movable arm oil cylinder 2 will not retract.

In the present embodiment, the movable arm damping valve assembly 3 further includes: a one-way throttle valve group 34 and a solenoid directional valve 35. A switching oil port of the damping valve core 33 is configured to communicate, via the one-way throttle valve block 34, with the solenoid directional valve 35. The solenoid directional valve 35 has two working positions for connecting or disconnecting the rodless cavity of the movable arm oil cylinder 2 with the energy accumulator X2. The one-way throttle valve group 34 is used for stable switching of the damping valve core 33. After the solenoid directional valve 35 receives a signal of the movable arm damping button, the movable arm damping function is enabled, and the damping valve core 33 is controlled by the control pressure for connection and disconnection between the rodless cavity of the movable arm oil cylinder 2 and the energy accumulator X2.

Herein, the energy accumulator X2 may be further provided with an overflow valve 31. The first damping oil port B is configured to communicate, via the overflow valve 31, with the energy accumulator X2, and thus the overflow valve 31 is used for limiting the pressure of the energy accumulator X2.

In order to facilitate releasing pressure in the energy accumulator X2 after machine is shutdown, the movable arm damping valve assembly 3 further includes a switch valve 32. The second damping oil port A is configured to communicate, via the switch valve 32, with the first damping oil port B, and the switch valve 32 has a connection position for connecting the first damping oil port B and the second damping oil port A, and a disconnection position for disconnecting the first damping oil port B and the second damping oil port A.

The switching of the damping lock valve 4 may be controlled by other pressures, such as the rod cavity pressure of the bucket oil cylinder can be used, to switch the damping lock valve 4. The bucket oil cylinder is similar in structure to the movable arm oil cylinder 2. The first oil port B1 of the bucket valve core 12 is configured to communicate with the rod cavity of the bucket oil cylinder, and the second oil port A1 of the bucket valve core 12 is configured to communicate with the rodless cavity of the bucket oil cylinder. If the switching oil port K of the damping lock valve 4 is in communication with the rod cavity of the bucket oil cylinder and the switching oil port of the damping lock valve 4 is not in communication with the rodless cavity of the bucket oil cylinder, the damping lock valve 4 is able to switch from the damping connection position to the damping disconnection position when the pressure at the switching oil port K of the damping lock valve 4 reaches a preset pressure.

It is understandable that the preset pressure at the switching oil port K of the damping lock valve 4 may be adjusted according to actual conditions. When the damping lock valve 4 is controlled by a pilot pressure of the unloading position, the preset pressure of the damping lock valve 4 is 5.0˜8.0 bar. When it is controlled by the rod cavity pressure of the bucket oil cylinder, the preset pressure is 50.0˜80.0 bar.

In the present application, an operation machinery is further provided. The operation machinery may be a loading machine. The loading machine includes the movable arm damping system for a loading machine. As shown in FIGS. 2-4, the movable arm damping system for the loading machine includes: a multi-way valve assembly 1, a movable arm oil cylinder 2, a movable arm damping valve assembly 3 and a damping lock valve 4. The multi-way valve assembly 1 includes: a movable arm valve core 11 and a bucket valve core 12. A first movable arm oil port B2 of the movable arm valve core 11 is configured to communicate with a rod cavity of the movable arm oil cylinder 2, a second movable arm oil port A2 of the movable arm valve core 11 is configured to communicate with a rodless cavity of the movable arm oil cylinder 2, the rod cavity of the movable arm oil cylinder 2 is configured to communicate with the movable arm damping valve assembly 3, the rodless cavity of the movable arm oil cylinder 2 is configured to communicate, via the damping lock valve 4, with the movable arm damping valve assembly 3. Herein, the damping lock valve 4 has a damping connection position and a damping disconnection position, a switching oil port K of the damping lock valve 4 is configured to communicate with a switching oil port b1 of the bucket valve core such that when a pressure of the switching oil port K of the damping lock valve 4 reaches a preset pressure during a bucket unloading process, the damping lock valve 4 switches from the damping connection position to the damping disconnection position.

During operation of the loading machine, after the operator turns off a movable arm damping button, the movable arm damping valve assembly 3 is off. During operation of bucket loading, the pressure in the rod cavity of the movable arm oil cylinder 2 increases and the oil liquid in the movable arm oil cylinder 2 will flow through the movable arm damping valve assembly 3 to the energy accumulator X2, and such process is called energy accumulator X2 filling. When the pressure in the rod cavity of the movable arm oil cylinder 2 is higher than 12.5 MPa, the movable arm damping valve assembly 3 cuts off the oil way connection between the rodless cavity of the movable arm oil cylinder 2 and the energy accumulator X2, and the movable arm damping function of is in the disabled state at this time.

After the operator turns on the movable arm damping button, the movable arm damping valve assembly 3 is on. When the bucket does not unload, there is no pressure at the switching oil port K of the damping lock valve 4, the damping lock valve 4 is in the damping connection position, the oil port of the damping lock valve 4 is connected, the rodless cavity of the movable arm oil cylinder 2 communicates with the oil port of the damping lock valve 4, the energy accumulator X2 communicates, via the movable arm damping valve assembly 3, with the oil port of the damping lock valve 4, so that the rodless cavity of the movable arm oil cylinder 2 communicates, via the movable arm damping valve assembly 3, with the energy accumulator X2, and the movable arm damping function is in the enabled state at this time. When the bucket unloads, there is a control pressure at the switching oil port K of the damping lock valve 4, the damping lock valve 4 is in the damping disconnection position, the oil port of the damping lock valve 4 is disconnected, the oil way between the rodless cavity of the movable arm oil cylinder 2 and the energy accumulator X2 is cut off by the damping lock valve 4, and the rodless cavity of the movable arm oil cylinder 2 communicates only with the second movable arm oil port A2 of the multi-way valve assembly 1. At this time, the movable arm valve core 11 of the multi-way valve assembly 1 is in the closed state, when the bucket unloads material and presses downward on the movable arm mechanism, the movable arm oil cylinder 2 will not retract.

The loading machine, as provided in the present application, is provided with the movable arm damping system for the loading machine as described above. By adding the damping lock valve 4 having the damping connection position and the damping disconnection position to connect the rodless cavity of the movable arm oil cylinder 2 with the movable arm damping valve assembly 3 and connect the switching oil port K of the damping lock valve 4 with the switching oil port b1 of the bucket valve core 12, the damping lock valve 4 is controlled by a pilot pressure of the unloading position such that when a pressure of the switching oil port K of the damping lock valve 4 reaches a preset pressure, the damping lock valve 4 switches from the damping connection position to the damping disconnection position, effectively solving the problem of significant decrease in bucket level/height due to bucket unloading and pressing downward on the movable arm mechanism, and ensuring stable operation of the movable arm damping system for the loading machine.

Finally, it should be noted that the above embodiments are only used for explaining, rather than limiting, the technical solutions of the present application. Though the present application has been explained in detail in combination with the above embodiments, it should be understood by those skilled in the art that the technical solutions as recorded in the above embodiments can be modified or some technical features therein can be substituted equivalently. For such modification or substitution, the technical solutions corresponding thereto will not substantially depart from the spirit and scope of the technical solutions of the embodiments in the present application.

What is claimed is:

1. A movable arm damping system for a loading machine, comprising:
a multi-way valve assembly, a movable arm oil cylinder, a movable arm damping valve assembly and a damping lock valve; wherein
the multi-way valve assembly comprises a movable arm valve core and a bucket valve core, a first movable arm oil port of the movable arm valve core is configured to communicate with a rod cavity of the movable arm oil cylinder, a second movable arm oil port of the movable arm valve core is configured to communicate with a rodless cavity of the movable arm oil cylinder, the rod cavity of the movable arm oil cylinder is configured to communicate with the movable arm damping valve assembly, and the rodless cavity of the movable arm oil cylinder is configured to communicate, via the damping lock valve, with the movable arm damping valve assembly; and
the damping lock valve is provided with a damping connection position and a damping disconnection position, and a switching oil port of the damping lock valve is configured to communicate with a switching oil port of the bucket valve core such that when a pressure at the switching oil port of the damping lock valve reaches a preset pressure during a bucket unloading process, the damping lock valve switches from the damping connection position to the damping disconnection position.

2. The movable arm damping system for the loading machine according to claim 1, further comprising an energy accumulator and an oil tank pipeline, wherein
the energy accumulator communicates with the rodless cavity of the movable arm oil cylinder via the movable arm damping valve assembly and the damping lock valve; and
the oil tank pipeline is configured to communicate with the movable arm damping valve assembly, the movable arm valve core and the bucket valve core for supplying oil.

3. The movable arm damping system for the loading machine according to claim 2, wherein the movable arm damping valve assembly comprises a damping valve core; and
the damping valve core is provided with a first damping oil port and a second damping oil port, the first damping oil port is configured to communicate the rod cavity of the movable arm oil cylinder with the oil tank pipeline, and the second damping oil port is configured to communicate the rodless cavity of the movable arm oil cylinder with the energy accumulator.

4. The movable arm damping system for the loading machine according to claim 3, wherein the damping valve core has a first working position, a second working position and a fourth working position; the fourth working position is configured for connection of the first damping oil port and connection of the second damping oil port, at the fourth working position, the first damping oil port communicates the rod cavity of the movable arm oil cylinder with the oil tank pipeline, and the second damping oil port communicates the rodless cavity of the movable arm oil cylinder with the energy accumulator; the first working position is configured for connection of the second damping oil port and disconnection of the first damping oil port, at the first working position, the rod cavity of the movable arm oil cylinder disconnects with the oil tank pipeline, and the second damping oil port communicates the rodless cavity of the movable arm oil cylinder with the energy accumulator; and the second working position is configured for disconnection of the first damping oil port and disconnection of the second damping oil port, at the second working position, the rod cavity of the movable arm oil cylinder disconnects with the oil tank pipeline, and the rodless cavity of the movable arm oil cylinder disconnects with the energy accumulator.

5. The movable arm damping system for the loading machine according to claim 4, wherein
the damping valve core further has a third working position for connecting the energy accumulator and the oil tank pipeline.

6. The movable arm damping system for the loading machine according to claim 3, wherein
the movable arm damping valve assembly further comprises a one-way throttle valve group and a solenoid directional valve; and
a switching oil port of the damping valve core is configured to communicate, via the one-way throttle valve group, with the solenoid directional valve, and the solenoid directional valve has two working positions for connecting or disconnecting the rodless cavity of the movable arm oil cylinder and the energy accumulator.

7. The movable arm damping system for the loading machine according to claim 3, wherein
the movable arm damping valve assembly further comprises an overflow valve; the first damping oil port is configured to communicate, via the overflow valve, with the energy accumulator, and the overflow valve is used for limiting the pressure of the energy accumulator.

8. The movable arm damping system for the loading machine according to claim 3, wherein the movable arm damping valve assembly further comprises a switch valve;
the second damping oil port is configured to communicate, via the switch valve, with the first damping oil port, the switch valve has a connection position for connecting the first damping oil port and the second damping oil port, and a disconnection position for disconnecting the first damping oil port and the second damping oil port.

9. A loading machine, comprising a movable arm damping system for the loading machine, the movable arm damping system for the loading machine comprising:
a multi-way valve assembly, a movable arm oil cylinder, a movable arm damping valve assembly and a damping lock valve; wherein
the multi-way valve assembly comprises a movable arm valve core and a bucket valve core, a first movable arm oil port of the movable arm valve core is configured to communicate with a rod cavity of the movable arm oil cylinder, a second movable arm oil port of the movable arm valve core is configured to communicate with a rodless cavity of the movable arm oil cylinder, the rod cavity of the movable arm oil cylinder is configured to communicate with the movable arm damping valve assembly, and the rodless cavity of the movable arm oil cylinder is configured to communicate, via the damping lock valve, with the movable arm damping valve assembly; and
the damping lock valve is provided with a damping connection position and a damping disconnection position, and a switching oil port of the damping lock valve is configured to communicate with a switching oil port of the bucket valve core such that when a pressure at the switching oil port of the damping lock valve reaches a preset pressure during a bucket unloading process, the damping lock valve switches from the damping connection position to the damping disconnection position.

10. The loading machine according to claim 9, wherein the movable arm damping system for the loading machine further comprises an energy accumulator and an oil tank pipeline,
the energy accumulator communicates with the rodless cavity of the movable arm oil cylinder via the movable arm damping valve assembly and the damping lock valve; and
the oil tank pipeline is configured to communicate with the movable arm damping valve assembly, the movable arm valve core and the bucket valve core for supplying oil.

11. The loading machine according to claim 10, wherein the movable arm damping valve assembly comprises a damping valve core; and
the damping valve core is provided with a first damping oil port and a second damping oil port, the first damping oil port is configured to communicate the rod cavity of the movable arm oil cylinder with the oil tank pipeline, and the second damping oil port is configured to communicate the rodless cavity of the movable arm oil cylinder with the energy accumulator.

12. The loading machine according to claim 11, wherein the damping valve core the damping valve core has a first working position, a second working position and a fourth working position; the fourth working position is configured for connection of the first damping oil port and connection of the second damping oil port, at the fourth working position, the first damping oil port communicates the rod cavity of the movable arm oil cylinder with the oil tank pipeline, and the second damping oil port communicates the rodless cavity of the movable arm oil cylinder with the energy accumulator; the first working position is configured for connection of the second damping oil port and disconnection of the first damping oil port, at the first working position, the rod cavity of the movable arm oil cylinder disconnects with the oil tank pipeline, and the second damping oil port communicates the rodless cavity of the movable arm oil cylinder with the energy accumulator; and the second working position is configured for disconnection of the first damping oil port and disconnection of the second damping oil port, at the second working position, the rod cavity of the movable arm oil cylinder disconnects with the oil tank pipeline, and the rodless cavity of the movable arm oil cylinder disconnects with the energy accumulator.

13. The loading machine according to claim 12, wherein
the damping valve core further has a third working position for connecting the energy accumulator and the oil tank pipeline.

14. The loading machine according to claim 11, wherein
the movable arm damping valve assembly further comprises a one-way throttle valve group and a solenoid directional valve; and
a switching oil port of the damping valve core is configured to communicate, via the one-way throttle valve group, with the solenoid directional valve, and the solenoid directional valve has two working positions for connecting or disconnecting the rodless cavity of the movable arm oil cylinder and the energy accumulator.

15. The loading machine according to claim 11, wherein
the movable arm damping valve assembly further comprises an overflow valve; the first damping oil port is configured to communicate, via the overflow valve, with the energy accumulator, and the overflow valve is used for limiting the pressure of the energy accumulator.

16. The loading machine according to claim 11, wherein the movable arm damping valve assembly further comprises a switch valve;
the second damping oil port is configured to communicate, via the switch valve, with the first damping oil port, the switch valve has a connection position for connecting the first damping oil port and the second damping oil port, and a disconnection position for disconnecting the first damping oil port and the second damping oil port.
